(19) United States
(12) Patent Application Publication
(10) Pub. No.: US 2026/0239181 A1
(43) Pub. Date: Aug. 13, 2026

(54) NETWORK NODES, USER EQUIPMENT AND METHODS PERFORMED THEREIN

(71) Applicant: Telefonaktiebolaget LM Ericsson (publ), Stockholm (SE)

(72) Inventors: Afshin ABTIN, Sollentuna (SE); Charles HEGARTY, Stockholm (SE); Håkan ÖSTERLUND, Ekerö (SE); Andreas ANULF, Lidingö (SE); Sorin SURDILA, Québec (CA); Mattias DAHLQVIST, Stockholm (SE)

(73) Assignee: Telefonaktiebolaget LM Ericsson (publ), Stockholm (SE)

(21) Appl. No.: 19/157,266

(22) PCT Filed: Mar. 6, 2024
(86) PCT No.: PCT/EP2024/055853

§ 371 Date: Aug. 15, 2025

Related U.S. Application Data
(60) Provisional application No. 63/488,526, filed on Mar. 6, 2023.

(51) Int. Cl. H04W 48/16; H04L 67/131; H04W 48/18

(52) U.S. Cl. CPC H04W 48/16; H04L 67/131; H04W 48/18

(57) ABSTRACT

Embodiments herein may relate to a method performed by a first network node (15) for handling communications in a communication network. The first network node (15) registers at a second network node (16), that the first network node supports a capability associated with a service related to AR and/or XR.

### TECHNICAL FIELD

Embodiments herein relate to network nodes, a user equipment (UE), and methods performed therein regarding wireless communication. Furthermore, a computer program product and a computer readable storage medium are also provided herein. In particular, embodiments herein relate to handling one or more services such as augmented reality (AR) and/or extended reality (XR) services in a communication network.

### BACKGROUND

In a typical communication network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

Specifications for the Evolved Packet System (EPS) have been completed within the 3GPP and coming 3GPP releases, such as New Radio (NR) and 6 generation (6G), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially non-hierarchical architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions. NR is connected to the 5G Core Network (5GC) which comprises a number of Network Functions (NF) such as Session Management Function (SMF), Access Management Function (AMF), Authentication Service Function (AUSF), Policy Control Function (PCF), Unified Data Manager (UDM), Network Repository Function (NRF), Network Exposure Function (NEF), just to mention some. In the 5GC, NFs can discover other NFs by using a discovery service provided by the NRF.

The Internet Protocol (IP) Multimedia Subsystem (IMS) is a well-known 3GPP standard allowing sessions to be setup between two or more parties for a broad variety of services such as voice or video call, interactive messaging sessions or third-party specific applications. A protocol chosen by 3GPP is the Session Initiation Protocol (SIP). The SIP provides a mechanism for registration of UEs and for setting up multimedia sessions. The SIP REGISTER method enables the registration of user agent's current location, and the SIP INVITE method enables the setting up of a session. IMS is implemented by Public Land Mobile Network (PLMN) operators as an architectural framework for delivering IP multimedia services to their subscribers. An IMS node may comprise one of the following:

A Home Subscriber Server (HSS); an HSS is a subscriber database comprising subscriber profiles, performs authentication and authorization, and provides information on services provisioned for subscribers and information on the location and IP address of a subscriber.

A Serving Call Session Control Function (S-CSCF); an S-CSCF is a SIP server and is the central signaling node in the IMS network and performs session control services for the UE. It handles SIP registrations and is responsible for forwarding SIP messages to the correct application server. The S-CSCF may behave as a SIP-proxy, i.e. it accepts requests and services them internally or forwards them.

Another entity is an outbound proxy of the UE, which is referred to as a Proxy-Call Session Control Function (P-CSCF). The P-CSCF routes requests to other CSCFs such as S-CSCFs.

Interrogating Call Session Control Function (I-CSCF); an I-CSCF is a SIP server and located at the edge of an administrative domain. Its IP address is published in the Domain Name System (DNS) of the domain, so that remote servers can find it and use it as a forwarding point for SIP packets to this domain.

Augmented reality (AR) may be defined as an interactive experience that combines the real world and computer-generated content. The content can span multiple sensory modalities, including visual, auditory, haptic, somatosensory, and olfactory. AR can be defined as a system that incorporates three basic features: a combination of real and virtual worlds, real-time interaction, and accurate three-dimensional (3D) registration of virtual and real objects.

In addition to the “AR” term the industry uses two other related terms. Mixed reality (MR) is an advanced form of AR where some virtual elements are inserted into the physical scene with the intent to provide the illusion that these elements are part of the real scene. Extended reality (XR) refers to all real-and-virtual combined environments and human-machine interactions generated by computer technology and wearables. It includes representative forms such as AR, MR and virtual reality (VR) and the areas interpolated among them. The levels of virtuality range from partially sensory inputs to fully immersive VR. A key aspect of XR is the extension of human experiences especially relating to the senses of existence, represented by VR, and the acquisition of cognition, represented by AR.

While it is herein mostly used the “AR” term in the description, but the terms “MR” and “XR” may equally be applied to embodiments herein.

AR has been in the last few years an area of intense research covering numerous topics e.g., glasses, device configurations, RAN, Packet Core and AR Service Network capabilities, AR codecs. As result 3GPP also started to work on AR requirements in release (Rel.) 16 and 17 see 26.998 v.18.0.0 and increased focus on AR solution specification in Rel.18 specifically related to conversational AR architecture and technologies. The 3GPP work is expected to continue in Rel. 19 and beyond.

Although some early market solutions may be seen today, industry analysts expect to see an increased AR market adoption starting with 2025, and to become a more mainstream technology starting with 2028.

Amongst the different AR use cases, one of the most challenging is Conversation AR in which any of the two or more parties involved in a conversation/conference can generate and consume AR content with the expected Quality of experience (QoE).

3GPP rel. 18 works on specifying three possible architectures for Conversational AR:
1. An IMS based architecture which uses and extends, when needed, the IMS and Data channel capabilities.
2. An architecture applicable for over the top (OTT), in which the AR system is handled by OTT which only uses RAN and Packet Core communication service provider (CSP) infrastructure and may use some AR enablers in the CSP network.
3. A new web-real time communication (WebRTC) based AR system architecture intended for CSPs and designed from scratch to be optimized for conversational AR, and to eliminate the need for backward compliance towards legacy networks. A simplified model covering both Model 1 and Model 3 can be found in FIG. 1.
   Both these models are targeted for CSPs, which intend to provide the AR System capabilities for AR applications running on mobile and fixed devices. Such AR system capabilities include but are not limited to AR user Authentication/Authorization, Addressing, Find and Connect, AR Capability negotiation between the devices involved in the AR call/conference, and/or charging.

As shown in FIG. 1, the AR application running on the device and in the network, the diagonal patterned rectangles, relies on the standardized capabilities of the AR System, dashed rectangles, so that the AR application can focus on the application logic only. In Model 1 the Conversation AR system is based on IMS and IMS Data Channel, while in Model 3 it is represented by a new WebRTC based AR system. This Model 3 Conversational System is expected to implement similar functionalities to those supported by IMS, however they will be more AR optimized and without the burden of backward compatibility. FIG. 1 shows a Generic representation of 3GPP Conversational AR Models 1 and 3.

Moreover, to access the AR system, the UE discovers the address of “entry point” server in the AR System, an AR Signaling Server (AR-SS), and use it to initiate Conversational AR session.

For completeness, with 3GPP Model 2 (not shown), the CSP network will provide the NR and 5GC Capabilities, while the AR system and the AR applications will be provided by the OTT.

The IMS architecture is specified by 3GPP and is described in 3GPP TS 23.228 v.17.3.0 and TS 24.229 v.17.8.1. 5GC architecture and procedures are specified in 23.501 v.17.6.0 and 23.502 v.17.6.0, and EPC architecture and procedures are specified in 23.401 v.18.0.0.

Further, a voice over LTE or voice over NR (VoLTE)/(VoNR) device, i.e., telephony over IMS, which is using IMS access point name (APN)/data network name (DNN) for telephony services, uses the procedure referred to as P-CSCF Discovery. The procedure implies that UE will receive the P-CSCF addresses during IMS packet data network (PDN) connection setup, in EPC, or IMS protocol data unit (PDU) session setup (in 5GC), where the P-CSCF addresses are the entry point of the IMS system. See further in GSMA PRD NG.114 v.2.0, § 4.7.

### SUMMARY

As part of developing embodiments herein one or more problems have been identified. A problem definition is slightly different depending on the 3GPP rel-18 discussed model, as follows:

For Model 3—The CSPs typically require dynamic methods through which the UE AR Application can discover the AR Signaling Server that represent the entry point for UE signaling into the AR System, either in the home network or on the visited network, e.g., when roaming. The dynamic discovery gives operators great flexibility in deploying and upgrading the AR Signaling Servers and in ensuring network recovery in case of AR server failure. For this Model 3, there is mainly one discovery solution discussed in the industry, based on UE and the network implementing a new framework for edge application referred as EDGE APP. Since the implementation of this framework is uncertain due to the UE impacts and due to lack of current consensus in 3GPP, there is a need to specify simpler discovery methods extending the current 3GPP procedures.

For Model 1—since this model is based on IMS, the AR Signaling Server acting as an entry point is a P-CSCF, and the P-CSCF discovery methods are well specified in 3GPP. However, it is anticipated that when the extra AR capabilities are rolled-out, the CSP will most likely select to deploy a limited set of P-CSCFs upgraded to support the new AR capabilities, i.e., they will not upgrade all P-CSCF in the network, at least not initially. The problem with the state-of-the-art discovery methods is that they allow discovery of a P-CSCF without being able to refine discovery to P-CSCF with specific capabilities. Note also that this topic is not discussed in scope of Rel-18.

For Model 2—Since the AR system is part of the OTT system, the AR signaling Server Discovery is an internal OTT issue. However, OTTs may benefit from the dynamic methods that will be described herein.

An object herein is to provide a mechanism to handle communication in an efficient manner to improve performance of UEs handling an AR service and/or extended reality service in a communication network.

According to an aspect the object is achieved, according to some embodiments herein, by providing a method performed by a first network node, such as a P-CSCF or AR-SS, for handling communications in a communication network. The first network node registers at a second network node that the first network node supports a capability associated with a service related to AR and/or XR.

According to another aspect the object is achieved, according to some embodiments herein, by providing a method performed by a second network node for handling communications in a communication network. The second network node receives an indication from a first network node, indicating that the first network node supports a capability associated with a service related to AR and/or XR; and stores the indication mapped to a node indication of the first network node.

According to yet another aspect the object is achieved, according to some embodiments herein, by providing a method performed by a third network node for handling communications in a communication network. The third network node receives from a UE, a request for a first network node supporting a service related to AR and/or XR, and obtains one or more indications of one or more first network nodes that supports the service related to AR and/or XR. The third network node further provides a response to the UE indicating the one or more first network nodes.

According to still yet another aspect the object is achieved, according to some embodiments herein, by providing a method performed by a UE for handling communication of the UE in a communication network. The UE sends to a third network node, a request for a first network node supporting a service related to AR and/or XR; and receives a response from the third network node with an indication indicating one or more first network nodes supporting the service related to AR and/or XR.

It is furthermore provided herein a computer program product comprising instructions, which, when executed on at least one processor, cause the at least one processor to carry out the methods herein, as performed by the UE or the network nodes, respectively. It is additionally provided herein a computer-readable storage medium, having stored thereon a computer program product comprising instructions which, when executed on at least one processor, cause the at least one processor to carry out the methods herein, as performed by the UE or the network nodes, respectively.

According to another aspect the object is achieved, according to some embodiments herein, by providing a first network node, such as a P-CSCF or AR-SS, for handling communications in a communication network. The first network node is configured to register at a second network node that the first network node supports a capability associated with a service related to AR and/or XR.

According to yet another aspect the object is achieved, according to some embodiments herein, by providing a second network node for handling communications in a communication network. The second network node is configured to receive an indication from a first network node, indicating that the first network node supports a capability associated with a service related to AR and/or XR; and to store the indication mapped to a node indication of the first network node.

According to yet still another aspect the object is achieved, according to some embodiments herein, by providing a third network node for handling communications in a communication network. The third network node is configured to receive from a UE, a request for a first network node supporting a service related to AR and/or XR, and to obtain one or more indications of one or more first network nodes that supports the service related to AR and/or XR. The third network node is further configured to provide a response to the UE indicating the one or more first network nodes.

According to another aspect the object is achieved, according to some embodiments herein, by providing a UE for handling communication of the UE in a communication network. The UE is configured to send to a third network node, a request for a first network node supporting a service related to AR and/or XR; and to receive a response from the third network node with an indication indicating one or more first network nodes supporting the service related to AR and/or XR.

The proposals herein may provide a way forward for the standardization of UE discovery of the AR Signaling Servers, and/or P-CSCFs, acting as an entry point in an AR and/or extended reality system. This will thus result in an improved performance of UEs handling an AR service and/or extended reality service in the communication network.

### BRIEF DESCRIPTION OF THE DRAWINGS

Embodiments will now be described in more detail in relation to the enclosed drawings, in which:

FIG. 1 shows a schematic architecture according to prior art;

FIG. 2 shows an overview depicting a communication network according to embodiments herein;

FIG. 3 shows a signalling scheme according to some embodiments herein;

FIG. 4 shows a signalling scheme according to some embodiments herein;

FIG. 5 shows a signalling scheme according to some embodiments herein;

FIG. 6 shows a flowchart illustrating a method performed by a first network node according to embodiments herein;

FIG. 7 shows a flowchart illustrating a method performed by a second network node according to embodiments herein;

FIG. 8 shows a flowchart illustrating a method performed by a third network node according to embodiments herein;

FIG. 9 shows a flowchart illustrating a method performed by a UE according to embodiments herein;

FIG. 10 shows a signalling scheme according to some embodiments herein;

FIG. 11 shows a signalling scheme according to some embodiments herein;

FIG. 12 shows a block diagram depicting embodiments of a first network node according to embodiments herein;

FIG. 13 shows a block diagram depicting embodiments of a second network node according to embodiments herein;

FIG. 14 shows a block diagram depicting embodiments of a third network node according to embodiments herein;

FIG. 15 shows a block diagram depicting embodiments of a UE according to embodiments herein;

FIG. 16 schematically illustrates a telecommunication network connected via an intermediate network to a host computer;

FIG. 17 is a generalized block diagram of a host computer communicating via a base station with a user equipment over a partially wireless connection; and

FIGS. 18, 19, 20, and 21 are flowcharts illustrating methods implemented in a communication system including a host computer, a base station and a user equipment.

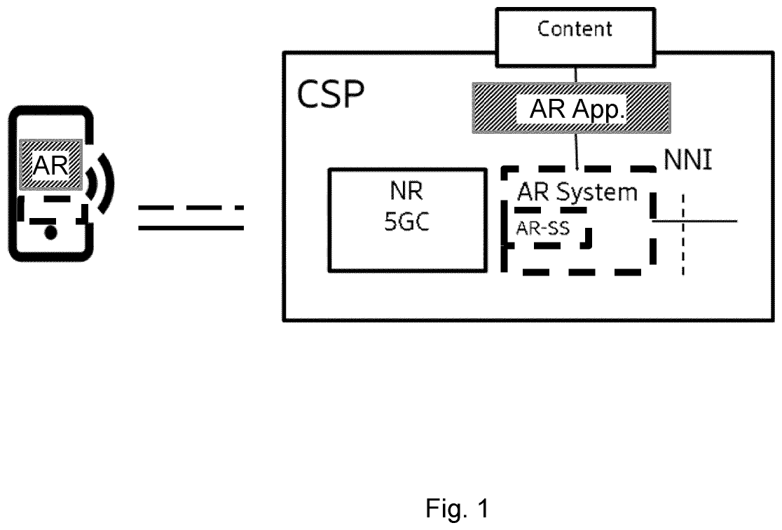

### DETAILED DESCRIPTION

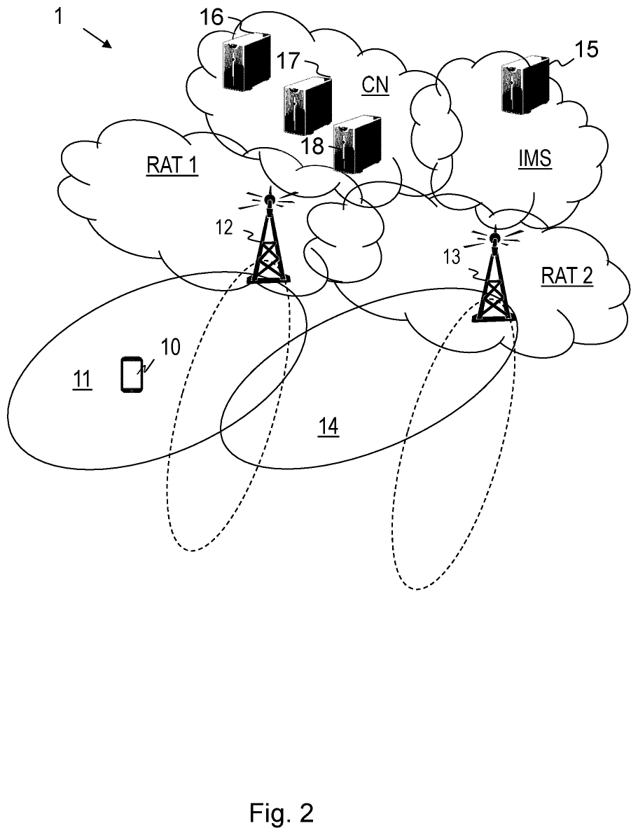

Embodiments herein relate to communication networks in general. FIG. 2 is a schematic overview depicting a communication network 1. The communication network 1 comprises one or more RANs and one or more CNs. The communication network 1 may use one or a number of different technologies. Embodiments herein relate to recent technology trends that are of particular interest in a New Radio (NR) context, however, embodiments are also applicable in further development of existing wireless communications systems such as e.g. LTE.

In the communication network 1, a user equipment (UE) 10 exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The communication network 1 comprises a first radio network node 12 or just radio network node, providing radio coverage over a geographical area, a first service area 11 or first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the first radio network node depending e.g. on the first radio access technology and terminology used. The first radio network node may be referred to as a serving radio network node wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage. The first radio network node 12 may be of a first PLMN.

The communication network 1 comprises a second radio network node 13 or just radio network node, providing radio coverage over a geographical area, a second service area 14 or second cell, of a second radio access technology (RAT), such as NR, LTE, or similar. The second radio network node 13 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the second radio network node depending e.g. on the first radio access technology and terminology used. The second radio network node may be referred to as a visiting radio network node or target radio network node, wherein the service area may be referred to as a visiting cell or target cell, and the second radio network node communicates with the UE in form of DL transmissions to the UE and UL transmissions from the UE. It should be noted that a service area may be denoted as cell, beam, beam group or similar to define an area of radio coverage.

The communication network may comprise a network comprising one or more first network nodes 15. For example, an access node, an IMS node or other network node.

The first network node 15 may comprise one of the following:

AR Signaling Server (AR-SS) being a node to access the AR system, the AR-SS is “entry point” server in the AR System, and may be used to initiate Conversational AR session.

Another entity is an outbound proxy of the UE 10, which is referred to as a Proxy-Call/Session Control Function (P-CSCF). The P-CSCF routes requests to other CSCFs such as S-CSCFs.

A Serving Call Session Control Function (S-CSCF); an S-CSCF is a SIP server and is the central signaling node in the IMS network and performs session control services for the UE. It handles SIP registrations and is responsible for forwarding SIP messages to the correct application server. The S-CSCF may behave as a SIP-proxy, i.e. it accepts requests and services them internally or forwards them.

Interrogating Call Session Control Function (I-CSCF); an I-CSCF is a SIP server and located at the edge of an administrative domain. Its IP address is published in the Domain Name System (DNS) of the domain, so that remote servers can find it and use it as a forwarding point for SIP packets to this domain.

The communication network 1 may further comprise a number of core network nodes providing, e.g. in NR, network functions (NF) or actually instantiations of NFs also referred to as NF instances, such as a second network node 16 providing, for example, an instantiation of a session management function (NRF), a fourth network node 17 providing an instantiation of an AMF, and a third network node 18 providing, for example, an instantiation of an SMF, or any other NF instances in the communication network 1. The different NF instances may have different tasks. Other functions may be for LTE such as Mobility Management Entity (MME) or similar. The third network node 18 may in some examples be a DHCP node such as a node that may automatically assign networking information, such as addresses, to a UE.

The respective node may be a standalone server, a cloud-implemented server, a distributed server or processing resources in a server farm or same node. Embodiments herein may be implemented as physical bare metal, virtual or cloud native such as Kubernetes environment in, e.g., hyper-cloud networks.

All the references to “AR” in this section will also apply to “XR”.

A mechanism is herein provided to enable the UE 10 to discover the first network node 15 such as the AR Signaling Server or P-CSCF node acting as an entry point.

Thus, embodiments shows a global interoperability between the UEs and communication networks, such as CSP networks, that depends on having standardized solution supported by both the UEs and the networks. The proposals herein may provide a way forward for the standardization of UE discovery of the AR Signaling Servers acting as an entry point in the CSP AR System. Moreover, for the Protocol Configuration Options (PCO) extension to support asking for the addresses, such as IP-addresses, of a P-CSCF with specific capabilities will greatly simplify and reduce the cost of the IMS based Conversational AR and/or XR deployments, especially in the early deployment steps.

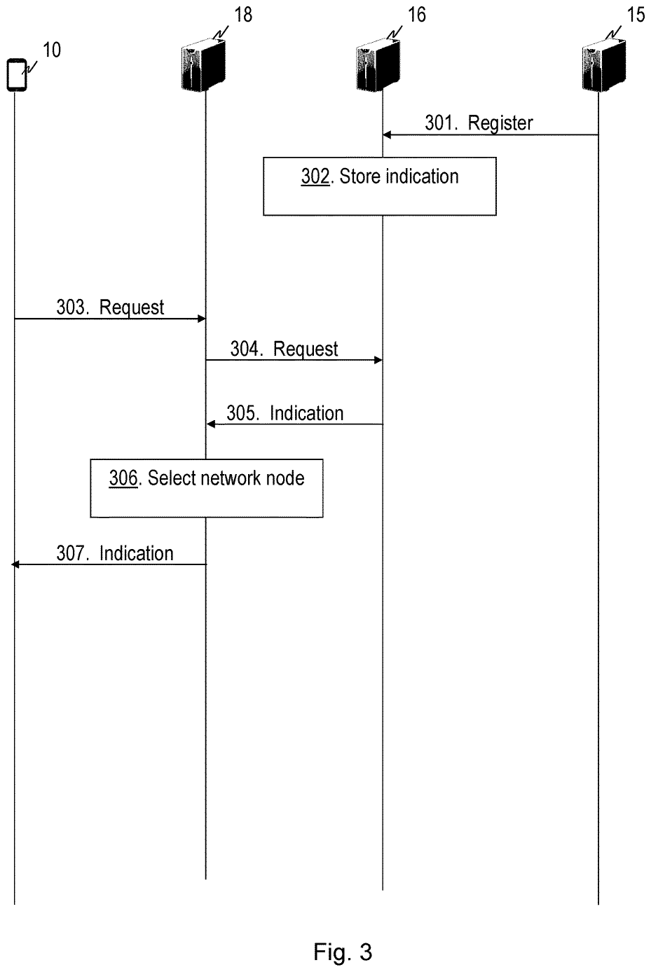

FIG. 3 is a combined flowchart and signalling scheme according to some embodiments herein.

Action 301. The first network node 15, such as a P-CSCF, registers at the second network node 16, such as a NRF, that it supports a capability associated with a service related to AR and/or XR.

Action 302. The second network node 16 stores an indication of capability of the first network node 15, wherein the capability is associated with a service related to AR and/or XR.

Action 303. The UE 10 sends to the third network node 18, a request for a first network node supporting a service related to AR and/or XR.

Action 304. The third network node 18 requests from the second network node 16 one or more first network nodes that supports the service related to AR and/or XR.

Action 305. The third network node 18 receives a response from the second network node 16, wherein the response comprises an indication indicating one or more first network nodes supporting a service related to AR and/or XR.

Action 306. The third network node 18 may select, from the response, a first network node or nodes supporting a service related to AR and/or XR.

Action 307. The third network node 18 then provides a response to the UE 10 with a same or different indication indicating the one or more first network node supporting the service related to AR and/or XR.

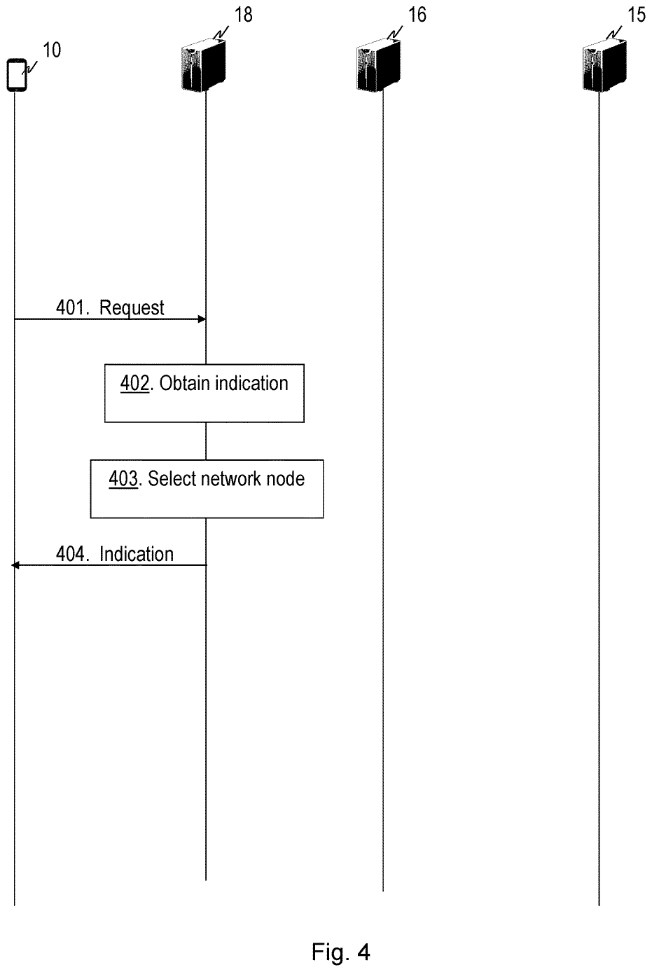

FIG. 4 is a combined flowchart and signalling scheme according to some embodiments herein.

Action 401. The UE 10 sends to the third network node 18, a request for a first network node supporting a service related to AR and/or XR.

Action 402. The third network node 18 obtains one or more indications of one or more first network nodes that supports the service related to AR and/or XR. This may be locally configured at the third network node 18.

Action 403. The third network node 18 may select one or more first network nodes supporting a service related to AR and/or XR.

Action 404. The third network node 18 then provides a response to the UE 10 with one or more indications indicating the respective first network node supporting the service related to AR and/or XR.

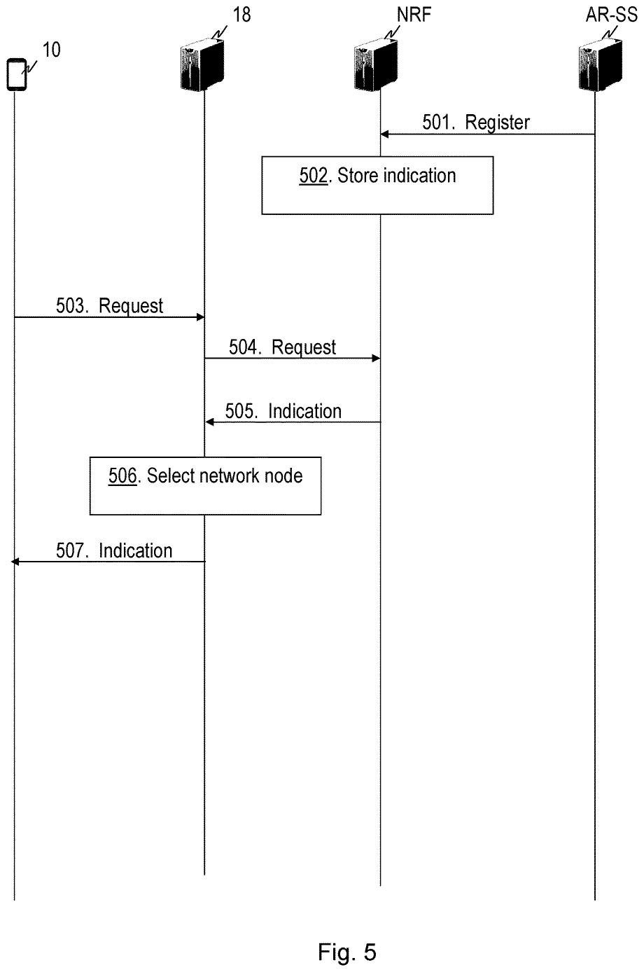

FIG. 5 is a combined flowchart and signalling scheme according to some embodiments herein.

Action 501. The first network node 15, for example, AR-SS, registers at a second network node 16, such as NRF, that it supports a capability associated with a service related to AR and/or XR.

Action 502. The second network node 16 stores an indication of the capability of the first network node 15, wherein the capability is associated with a service related to AR and/or XR.

Action 503. The UE 10 sends to the third network node 18, such as the SMF, a request for a first network node supporting a service related to AR and/or XR.

Action 504. The third network node 18 requests from the second network node 16 one or more first network nodes that supports the service related to AR and/or XR.

Action 505. The third network node 18 receives a response from the second network node 16, wherein the response comprises an indication indicating one or more first network nodes supporting a service related to AR and/or XR.

Action 506. The third network node 18 may select the first network node 15 supporting a service related to AR and/or XR. For example, the third network node 18, such as an SMF, may compile a list of most suitable first network nodes, and the list may be sent to the UE 10.

Action 507. The third network node 18 then provides a response to the UE 10 with a same or different indication indicating the first network node 15 supporting the service related to AR and/or XR. For example, the third network node 18 may send a list of first network nodes to the UE 10.

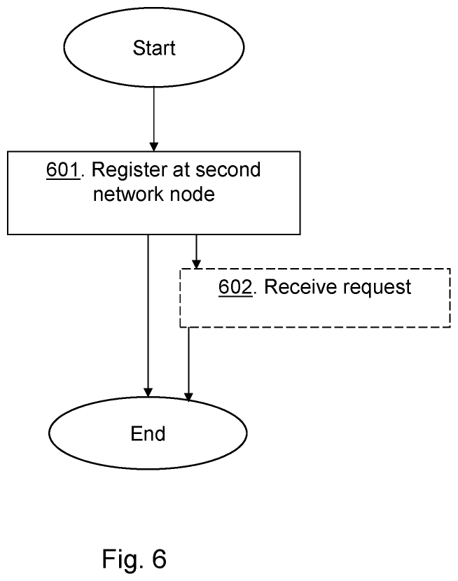

The method actions performed by the first network node 15, such as a P-CSCF, an entry point, an AR-SS or another network node, for handling communications in the communication network, for example, handling a service, according to embodiments herein will now be described with reference to a flowchart depicted in FIG. 6. The actions do not have to be taken in the order stated below, but may be taken in any suitable order. Actions performed in some embodiments are marked with dashed boxes.

Action 601. The first network node 15 registers at the second network node 16, NRF, that it supports a capability associated with a service related to AR and/or XR. Thus, the first network node 15 may transmit an indication indicating that it supports a capability associated with a service related to AR and/or XR.

Action 602. The first network node 15 may receive a request from the third network node 18 to initiate a service related to AR and/or extended reality for the UE 10. The first network node 15 may receive a request from the UE 10 to initiate a service related to AR and/or XR for the UE 10. Thus, the first network node such as a P-CSCF or an AR-SS, may be contacted directly from the UE 10.

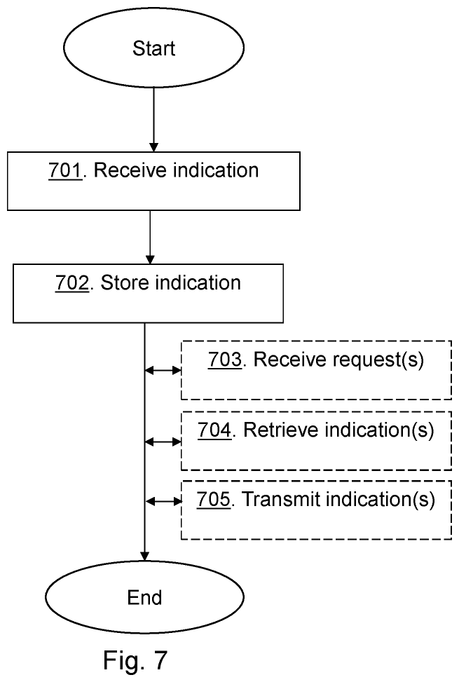

The method actions performed by the second network node 16, such as a NRF or another network node, for handling communications in the communication network, for example, handling a service, according to embodiments herein will now be described with reference to a flowchart depicted in FIG. 7. The actions do not have to be taken in the order stated below, but may be taken in any suitable order. Actions performed in some embodiments are marked with dashed boxes.

Action 701. The second network node 16 receives the indication from the first network node 15, indicating that the first network node 15 supports the capability associated with a service related to AR and/or XR.

Action 702. The second network node 16 stores the indication mapped to a node indication of the first network node 15. That is, a capability may be mapped to a node ID.

Action 703. The second network node 16 may receive from the third network node 18 one or more requests for one or more first network nodes that supports the service related to AR and/or XR.

Action 704. The second network node 16 may retrieve one or more indications of first network nodes that supports the service related to AR and/or XR.

Action 705. The second network node 16 may then transmit one or more indications of first network nodes that supports the service related to AR and/or XR.

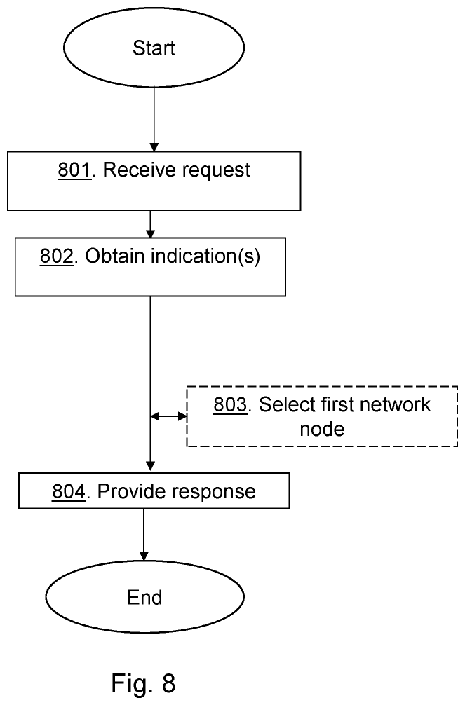

The method actions performed by the third network node 18, such as a SMF or a DHCP, or another network node, for handling communications in the communication network, for example, handling a service, according to embodiments herein will now be described with reference to a flowchart depicted in FIG. 8. The actions do not have to be taken in the order stated below, but may be taken in any suitable order. Actions performed in some embodiments are marked with dashed boxes.

Action 801. The third network node 18 receives from the UE 10, a request for a first network node supporting a service related to AR and/or XR.

Action 802. The third network node 18 obtains indications of one or more first network nodes that supports the service related to AR and/or extended reality. For example, the third network node 18, such as the SMF, may request from the second network node 16 one or more first network nodes that supports the service related to AR and/or XR, or retrieve it internally, such as the DHCP. The third network node 18 may receive the response from the second network node 16, wherein the response comprises an indication indicating one or more first network nodes supporting a service related to AR and/or XR.

Action 803. The third network node 18 may select a first network node, or one or more first network nodes, supporting a service related to AR and/or XR. For example, the third network node 18, such as an SMF, may compile a list of most suitable first network nodes.

Action 804. The third network node 18 then provides the response to the UE 10 indicating the one or more first network nodes. The third network node 18 may provide the response to the UE 10 with a same or different indication as the obtained indications indicating the first network node 15 supporting the service related to AR and/or XR. For example, the third network node 18 may send one indication of the first network node or a list of first network nodes to the UE 10.

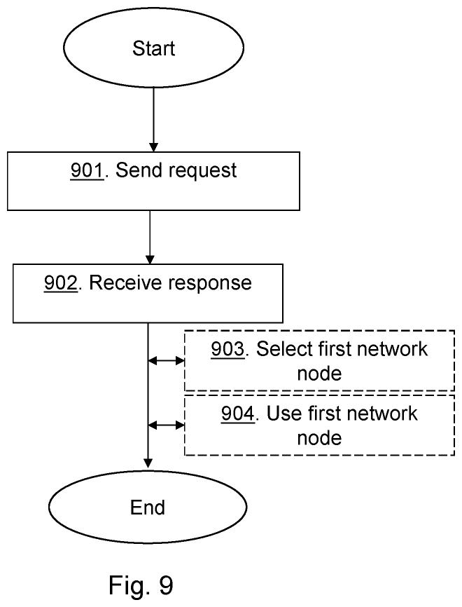

The method actions performed by the UE 10 for handling communication of the UE 10 in the communication network, for example, handling a service, according to embodiments herein will now be described with reference to a flowchart depicted in FIG. 9. The actions do not have to be taken in the order stated below, but may be taken in any suitable order. Actions performed in some embodiments are marked with dashed boxes.

Action 901. The UE 10 sends to the third network node 18, the request for the first network node supporting a service related to AR and/or XR.

Action 902. The UE 10 then receives the response from the third network node 18 with the indication indicating one or more first network nodes supporting the service related to AR and/or XR. For example, the UE 10 may receive the list from the third network node 18 indicating one or more first network nodes.

Action 903. The UE 10 may then select a first network node from the list.

Action 904. The UE 10 may use the first network node for AR service and/or extended reality service.

Embodiments herein provide one or more of the following:

For Model 3 (and possibly Model 2)—embodiments herein may provide three dynamic methods through which the UE 10, or an AR application in the UE 10, can discover the AR Signaling Server acting as an entry point for the CSP AR System.

For Model 1—embodiments herein may extend the P-CSCF discovery method based on 5GS/EPC supported procedures relying on Protocol Configuration Options (PCO), allowing the UE 10 to not only ask for a P-CSCF address but also to ask for a P-CSCF with specific capabilities e.g., Conversational AR.

Embodiments herein disclose different solutions such as:

1. Extend Enhanced PCO (ePCO) for Discovering P-CSCFs with Specific AR Capabilities (for Model 1).
UE Application can request the network for the IP address(es) of P-CSCF with specific capabilities e.g., Conversational AR
Extend ePCO information element to support requesting for addresses of P-CSCFs with specific capabilities e.g., Conversational AR.
Extend SMF behavior to consider the extension of the ePCO information element in the P-CSCF discovery query. Moreover, add the P-CSCF capability information to the NF discover query sent from SMF to NRF
Extend P-CSCF NF profile to include P-CSCF capabilities, e.g., to support Conversational AR support indication
For example, Network node (NN), being an example the first network node 15, transmits indication with capability.
NN1, being an example the second network node 16, receives and registers NN with capability.
UE 10 sends request for network node with capabilities.
NN2, being an example the third network node 18, receive request from UE 10, requests from NN1 for NN with capability, receives a response, and send response to the UE 10.
   2. Extend ePCO for Discovering AR Signaling Servers (for Model 3).
UE Application can request the network for the IP address(es) of AR-SS and eventually specific AR-SS Capabilities.
Define a new NF-Type, and a new NF-Type Profile for the AR-SS, to be used for NRF based discovery
Extend ePCO parameter definition to allow the AR-SS Address request and AR-SS Address Response. Additionally, ePCO can be extended to allow specifying AR-SS capabilities
Extend 5GC procedures and SMF/NRF behaviors to use ePCO based discovery for AR-SS.
NN transmits indication with capability.
NN1 receives and registers NN with capability.
UE 10 sends request to NN2 for indication of access point.
NN2 receive request from UE 10, requests from NN1 for NN with capability, receives a response, and send response to the UE 10.

### 3. Define UE Derivation of a “Well-Known” AR Signaling Server Uniform Resource Indicator (URI) (for Model 3)·

Proposes a mechanism to derive a well-known AR-SS URI for a UE equipped either with an Universal Subscriber Identity Module (USIM) or with an Integrated Subscriber Identity Module (ISIM).
NN2 receive request from UE 10, obtains a response indicating NN with capability, and send response to the UE 10.

### 4. Define a New Dynamic Host Configuration Protocol (DHCP) Option for Discovering AR Signaling Servers (for Model 1& 3).

Defines new DHCP Options to allow the UE (typically connected to a fixed access network) to discover the AR-SS either on IPv4 or IPv6 networks.

The NN2 (DHCP) is contacted by the UE 10 to get the address of the AR-SS.

Thus, embodiments herein show in detail four different solutions with their impacts and applicability. All the references to “AR” in this section will also apply to “XR”.

Extend ePCO for Discovering P-CSCFs with Specific AR Capabilities (for Model 1)

The existing 3GPP 5GC/EPC procedures allow the UE 10 to request the network to provide the IPV4 or IPV6 addresses of the first network node 15 such as the P-CSCF. With this solution the existing procedures and parameters will be extended to allow the UE 10 to request the Packet Core network to provide the IPV4 or IPV6 address of a P-CSCF with specific capabilities. The solution presentation will use for exemplification the P-CSCF capability to support Conversational AR sessions. However, the solution is generic hence allowing for addition of any to other P-CSCF capabilities.

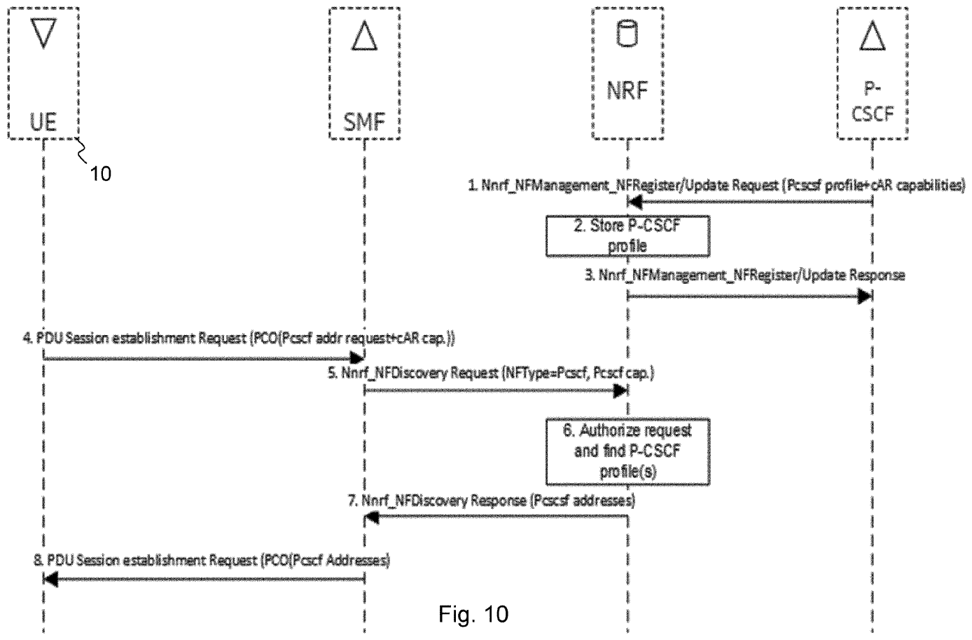

FIG. 10 describes an example of the 5GS procedure used by the UE 10 to require a P-CSCF Address and indicates some of the required extension to allow for requesting for a P-CSCF with specific capabilities e.g., support for Conversational AR. This procedure is based on using the PCO information element. Thus, FIG. 10 shows a 5GS procedure used by the UE 10 to discover a P-CSCF, with the necessary extensions to ask for specific P-CSCF capabilities.

Actions 1-3. The P-CSCF, being an example of the first network node 15, registers with the NRF, being an example of the second network node 16. The message carries the P-CSCF NF profile, which is extended to contain the information about Conversational AR (CAR) capabilities. Please note, the current P-CSCF NF Profile defined in 29.510 v.17.8.0 section “6.1.6.2.53 Type: PcscfInfo” does not include any P-CSCF specific capabilities, hence this information element will be extended with an additional attribute to contain such capabilities. The NRF stores the P-CSCF profile and confirms with a response.

Action 4. The UE 10, during the PDU Session Establishment Request, will ask the network to provide the P-CSCF address(es) and in addition to the existing procedure, will also specify that the P-CSCF must support Conversational AR capabilities. The current format of the PCO fields to require a P-CSCF address is defined in 24.008 Section 10.5.6.3 Protocol configuration options and is depicted below. The current specification indicates:

Container ID values for MS to network direction:
0001H (P-CSCF IPv6 Address Request).
000CH (P-CSCF IPV4 Address Request);

Container ID values for Network to MS direction:
0001H (P-CSCF IPv6 Address);
000CH (P-CSCF IPv4 Address);
The Container ID contents must be empty

Container ID 1
Length of container ID 1 contents
Container ID 1 contents
. . .

Current PCO field structure used for requesting a P-CSCF address

In some embodiments herein the Container ID Contents field may be used to carry the information about the required P-CSCF capabilities in the UE 10 to the network direction. The container ID Contents will contain an octet and each bit can be allocated a predefined capability, for example bit 1, if set to 1, indicates the request for a P-CSCF with Conversational AR capabilities.

Action 5. When SMF, being an example of the third network node 18, receives the UE request, the SMF uses the NRF to find the P-CSCF instances capable to support the Conversational AR. The solution proposes to extend e.g. the Query-Params-Ext3 see 29.510 v.17.8.0 Table 6.2.9-1: Features of supportedFeatures attribute used by Nnrf_NFDiscovery service, to indicate Conversational AR.

Optionally the SMF can have a local configuration, in which case the NRF query is skipped.

Action 6. NRF authorizes the SMF request and searches for the P-CSCF that indicated in their profile the support of Conversational AR capability.

Actions 7-8. The addresses of the P-CSCF capable for conversational AR are returned to the UE 10 in the already defined Container IDs. Optionally the Container ID Contents can also include the value as the one indicated in the MS to Network direction, to indicate to the UE 10 that the return IP Address is for a P-CSCF capable to support Conversational AR.

Note: The same PCO extensions are applicable for EPS, in which case the Packet Data Network Gateway (PGW) NF will have to have a new local configuration considering the PCO extensions and return the P-CSCF with Conversational AR Capabilities address.

Extend ePCO for Discovering AR Signaling Servers (for Model 3).

The concept of an AR-SS Network Function/Logical Entity acting as a UE signaling entry point in the operators' network is currently discussed in 3GPP Rel 18.

This solution provides a UE mechanism to dynamically discover the AR-SS, being an example of the second network node 16, when the UE 10 establishes the PDU Session/PDN Connection to the AR allocated DNN/APN, by extending the current ePCO based discovery mechanisms.

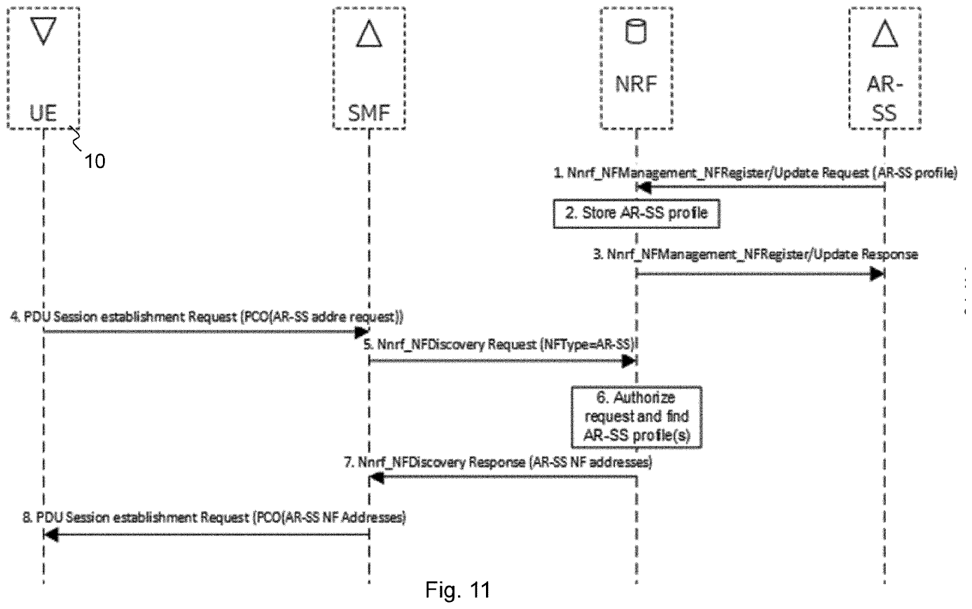

FIG. 11 describes the 5GS procedure used by the UE 10 to establish the PDU session, with the necessary extensions to require the address of the AR-SS. Please note the basic procedure is the same as the one described in FIG. 10, however, FIG. 11 focuses on the modification required to address the selection of AR-SS. Thus, the FIG. 11 shows a 5GS procedure used by UE 10 to discover the AR-SS.

Actions 1-3—The AR-SS registers with the NRF and the message carries the AR-SS NF profile. To make this possible the solution proposes to define a new NF-Type and a new NF-Type Profile following the framework outlined in 3GPP 29.510 v. 17.8.0 specification. The NRF stores the AR-SS profile and confirms with a response.

Action 4. The UE 10, during the PDU Session Establishment Request, will ask the network to provide the AR-SS address(es) by using the PCO parameter extended accordingly. The current format of the PCO fields to require a P-CSCF address is defined in 24.008 v.18.1.0 section 10.5.6.3 Protocol configuration options and is depicted above. The AR-SS specific extension will involve defining new Container ID values as follows:

### Two New Container ID Values for UE to Network Direction: One for IPV6 and One for IPv4 e.g.:

0040H (AR-SS IPV6 Address Request)
0041H (AR-SS IPv4 Address Request)

### Two New Container ID Values for the Network to UE Direction: One for IPV6 and One for IPV4

0040H (AR-SS IPV6 Address)
0041H (AR-SS IPv4 Address)

Moreover, following the same logic outlined in section 0, AR-SS PCO Container can also be extended to request specific AR-SS capabilities, by using the AR-SS Container Contents field, not specifically shown in FIG. 11.

Action 5. When SMF receives the UE request, uses the NRF to find the AR-SS. The SMF behavior needs to be enhanced to understand the new AR-SS ePCO semantic, and to use the newly defined AR-SS NF Type.

Optionally the SMF can have a local configuration, in which case the NRF query is skipped.

Action 6. NRF recognizes the new AR-SS NF-Type and authorizes the SMF request and searches for the AR-SS.

Actions 7-8 The addresses of the AR-SS are returned to the UE 10 in the newly defined AR-SS Container IDs.

Note: The same PCO extensions are applicable for EPS, in which case the PGW NF will have to have a new local configuration considering the PCO extensions and return the AR-SS address.

### Define UE Derivation of a “Well-Known” AR Signaling Server URI (for Model 3)

The solution proposes to define a well-known AR-SS URI and the UE procedure to derive this URI. The derived URI will be resolved by the UE 10 to the AR-SS IP address using the existing DNS mechanisms. Moreover, this URI will only be used when the UE AR Application was not pre-provisioned with an AR-SS URI, i.e., a pre-provisioned AR-SS URI will take precedence over the derived one.

The Proposed URI May have the Following Format:
<schema>: [//]<arss-label>.<domain>

Where:
<schema> will represent the protocol selected for Conversation AR. This protocol is under discussion in 3GPP Rel 18. It is possible the 3GPP decided schema will be “http”
[//]—The authority string “//” is optional and its usage will depend on the schema selected by 3GPP
<arss-label>. is the label indicating the URI refers to a AR-SS. The value will be defined in 3GPP. For exemplification we will use the string “arss”
<domain> identifies the domain hosting the AR-SS server. For the derivation of the label please see below.

The UE procedure to the AR-SS URI is as follows:

The first label shall be “<arss-label>” (to be defined in 3GPP).

The next label(s) shall identify the home network as follows:
1. When the UE has an ISIM, the domain name from the IP Multimedia Private Identity (IMPI) shall be used, see 3GPP TS 31.103 v.17.0.0, as follows:
a. if the last two labels of the domain name from the IMPI are “3gppnetwork.org”:
   i. the next labels shall be all labels of the domain name from the IMPI apart from the last two labels; and
   ii. the last three labels shall be “pub.3gppnetwork.org”;
b. if the last two labels of the domain name from the IMPI are other than the “3gppnetwork.org”:
   i. the next labels shall be all labels of the domain name from the IMPI;
2. When the UE 10 has a USIM and does not have ISIM, the home network shall be “<xr-system>.mnc<MNC>.mcc<MCC>.pub.3gppnetwork.org” where <MNC> and <MCC> shall be derived from the components of the International Mobile Subscriber Identity (IMSI). If there are only two significant digits in the MNC, one “0” digit shall be inserted at the left side to fill the 3 digits coding of MNC in the Fully Qualified Domain Name (FQDN) of AR-SS URI. The <xr-system> label identifies the AR and/or XR system that the AR-SS is the entry point for. For exemplification we will use the string “car” meaning “Conversational AR” System.

As an example, for the case when the UE 10 has the ISIM, where the IMPI is “user@operator.com”, the Default AR-SS URI used by the UE 10 would be:

### Example 1: “http://arss.operator.com”

As an example, for the case when the UE 10 has the ISIM, where the IMPI is “234150999999999@ims.mnc015.mcc234.3gppnetwork.org”, the Default AR-SS URI used by the UE would be:

### Example 2: “http://arss.car.mnc015.mcc234.pub.3gppnetwork.org”

As an example, for the case when the UE 10 has USIM and does not have ISIM, where the MCC is 345 and the MNC is 12, the overall AR-SS URI created and used by the UE 10 would be:

### Example 3: “http://arss.car.mnc012.mcc345.pub.3gppnetwork.org”

### Define a New DHCP Option for Discovering AR Signaling Servers (for Model 1 & 3)

Using the DHCP-Dynamic Host Configuration Protocol is another option for discovering an AR-SS, specific for UEs that are not connected to a 3GPP wireless network, e.g., devices connected in the wireline internet. The DHCP is defined in RFC 2131 for IPV4 and in RFC 3315 for IPV6 (DHCPv6). DHCP is a network management protocol that provides configuration parameters to Internet hosts. Besides allowing Internet hosts to dynamically be allocated an IP address, DHCP also allows them to discover entry-point signaling servers.

In order to allow UEs to discover AR-SS through DHCP, the protocol needs to be extended with a so called “DHCP option”, which when standardized in IETF requires registration with Internet Assigned Numbers Authority (IANA). For the currently defined DHCP options please see Dynamic Host Configuration Protocol (DHCP) and Bootstrap Protocol (BOOTP) Parameters (iana.org) for IPV4 and https://www.iana.org/assignments/dhcpv6-parameters/dhcpv6-parameters.xhtml for IPV6.

This solution defines a new DHCP protocol option for specific discovery of AR-SS servers:

For IPV4 the proposal is to use one of the unassigned option code, e.g., 163. For the option encoding, it is possible to use the same format as defined in RFC 3361 sections 3.1 and 3.2.

For IPV6 the proposal is to use two unassigned option codes as follows:
One for AR-SS Domain name list (Augmented Reality Signaling Server_D), with option code e.g., 145
One for AR-SS IPV6 Address List (Augmented Reality Signaling Server_A), with option code e.g., 146

For both option codes the encoding can follow the same format as defined in RFC 3319 sections 3.1 and 3.2.

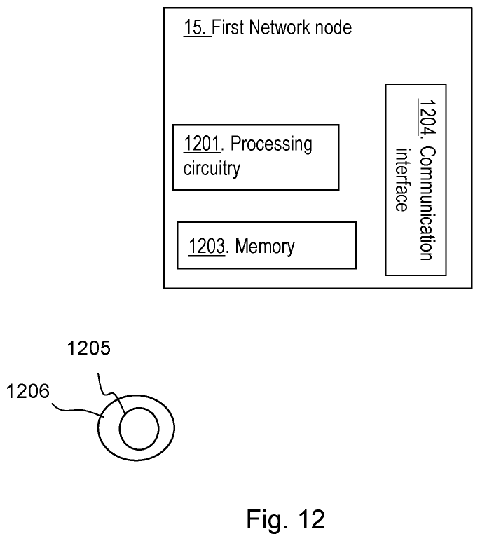

FIG. 12 are block diagrams depicting the first network node 15 such as a P-CSCF, an entry point, AR-SS, or another network node, for handling communications in the communication network 1, for example, handling a service, according to embodiments herein.

The first network node 15 may comprise processing circuitry 1201, e.g. one or more processors, configured to perform the methods herein.

The first network node 15 and/or the processing circuitry 1201 is configured to register at the second network node 16 that it supports the capability associated with a service related to AR and/or XR. Thus, the first network node 15 and/or the processing circuitry 1201 may be configured to transmit the indication indicating that it supports a capability associated with a service related to AR and/or XR.

The first network node 15 and/or the processing circuitry 1201 may be configured to receive the request from the third network node to initiate a service related to AR and/or extended reality for the UE 10. The first network node 15 and/or the processing circuitry 1201 may be configured to receive the request from the UE 10 to initiate the service related to AR and/or XR for the UE 10.

The first network node 15 may comprise a memory 1203. The memory 1203 comprises one or more units to be used to store data on, such as data packets, capabilities, indications, services, IDs, messages, thresholds, events and applications to perform the methods disclosed herein when being executed, and similar. Furthermore, the first network node 15 may comprise a communication interface 1204 such as comprising a transmitter, a receiver, a transceiver and/or one or more antennas.

The methods according to the embodiments described herein for the first network node 15 are respectively implemented by means of e.g. a computer program product 1205 or a computer program, comprising instructions, i.e., software code portions, which, when executed on at least one processor, cause the at least one processor to carry out the actions described herein, as performed by the first network node 15. The computer program product 1205 may be stored on a computer-readable storage medium 1206, e.g., a disc, a universal serial bus (USB) stick or similar. The computer-readable storage medium 1206, having stored thereon the computer program product, may comprise the instructions which, when executed on at least one processor, cause the at least one processor to carry out the actions described herein, as performed by the first network node 15. In some embodiments, the computer-readable storage medium may be a transitory or a non-transitory computer-readable storage medium. Thus, embodiments herein may disclose the first network node for handling communication in a communication network, wherein the first network node comprises processing circuitry and a memory, said memory comprising instructions executable by said processing circuitry whereby said first network node is operative to perform any of the methods herein.

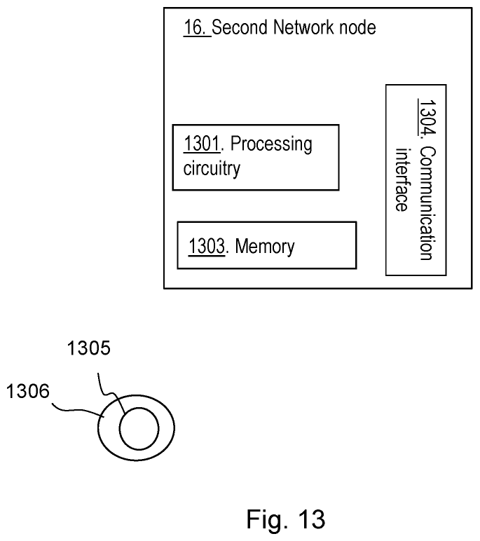

FIG. 13 are block diagrams depicting the second network node 16 such as a NRF or another network node, for handling communications in the communication network 1, for example, handling a service, according to embodiments herein.

The second network node 16 may comprise processing circuitry 1301, e.g. one or more processors, configured to perform the methods herein.

The second network node 16 and/or the processing circuitry 1301 is configured to receive the indication from the first network node 15, indicating that the first network node 15 supports the capability associated with a service related to AR and/or XR.

The second network node 16 and/or the processing circuitry 1301 is configured to store the indication mapped to the first network node 15.

The second network node 16 and/or the processing circuitry 1301 may be configured to receive from the third network node one or more requests for one or more first network nodes that supports the service related to AR and/or XR.

The second network node 16 and/or the processing circuitry 1301 may be configured to retrieve one or more indications of first network nodes that supports the service related to AR and/or XR.

The second network node 16 and/or the processing circuitry 1301 may be configured to transmit one or more indications of first network nodes that supports the service related to AR and/or XR.

The second network node 16 may comprise a memory 1303. The memory 1303 comprises one or more units to be used to store data on, such as data packets, capabilities, indications, services, IDs, messages, thresholds, events and applications to perform the methods disclosed herein when being executed, and similar. Furthermore, the second network node 16 may comprise a communication interface 1304 such as comprising a transmitter, a receiver, a transceiver and/or one or more antennas.

The methods according to the embodiments described herein for the second network node 16 are respectively implemented by means of e.g. a computer program product 1305 or a computer program, comprising instructions, i.e., software code portions, which, when executed on at least one processor, cause the at least one processor to carry out the actions described herein, as performed by the second network node 16. The computer program product 1305 may be stored on a computer-readable storage medium 1306, e.g., a disc, a universal serial bus (USB) stick or similar. The computer-readable storage medium 1306, having stored thereon the computer program product, may comprise the instructions which, when executed on at least one processor, cause the at least one processor to carry out the actions described herein, as performed by the second network node 16. In some embodiments, the computer-readable storage medium may be a transitory or a non-transitory computer-readable storage medium. Thus, embodiments herein may disclose the second network node 16 for handling communication in a communication network, wherein the second network node 16 comprises processing circuitry and a memory, said memory comprising instructions executable by said processing circuitry whereby said second network node 16 is operative to perform any of the methods herein.

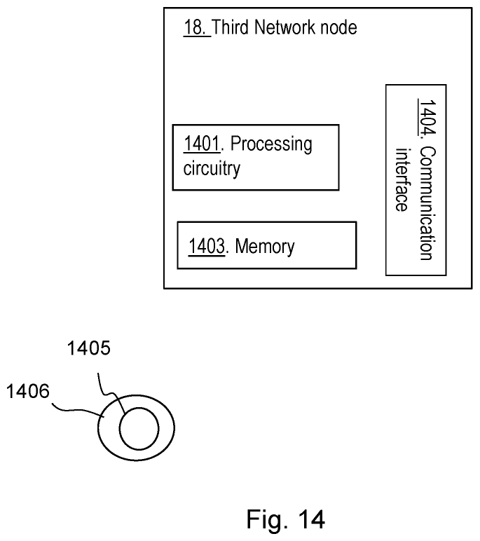

FIG. 14 are block diagrams depicting the third network node 18, such as a SMF, DHCP, or another network node, for handling communications in the communication network 1, for example, handling a service, according to embodiments herein.

The third network node 18 may comprise processing circuitry 1401, e.g. one or more processors, configured to perform the methods herein.

The third network node 18 and/or the processing circuitry 1401 is configured to receive from the UE 10, the request for a first network node, such as one or more first network nodes, supporting a service related to AR and/or XR.

The third network node 18 and/or the processing circuitry 1401 is configured to obtain indications of one or more first network nodes that supports the service related to AR and/or extended reality. For example, the third network node 18 and/or the processing circuitry 1401 may be configured to request from the second network node 16 for one or more first network nodes that supports the service related to AR and/or XR, or retrieve it internally. In case the third network node 18 is a DHCP, the DHCP may be configured with the respective addresses of the first network nodes.

The third network node 18 and/or the processing circuitry 1401 may be configured to receive the response from the second network node 16, wherein the response comprises the indication indicating one or more first network nodes supporting a service related to AR and/or XR.

The third network node 18 and/or the processing circuitry 1401 may be configured to select a first network node supporting a service related to AR and/or XR. The third network node 18 and/or the processing circuitry 1401 may be configured to compile the list of most suitable first network nodes.

The third network node 18 and/or the processing circuitry 1401 is configured to provide the response to the UE 10 indicating the one or more first network nodes. The third network node 18 and/or the processing circuitry 1401 may be configured to provide the response with a same or different indication indicating the first network node supporting the service related to AR and/or XR. The third network node 18 and/or the processing circuitry 1401 may be configured to send the list of first network nodes to the UE 10.

The third network node 18 may comprise a memory 1403. The memory 1403 comprises one or more units to be used to store data on, such as data packets, capabilities, indications, services, IDs, messages, list, thresholds, events and applications to perform the methods disclosed herein when being executed, and similar. Furthermore, the third network node 18 may comprise a communication interface 1404 such as comprising a transmitter, a receiver, a transceiver and/or one or more antennas.

The methods according to the embodiments described herein for the third network node 18 are respectively implemented by means of e.g. a computer program product 1405 or a computer program, comprising instructions, i.e., software code portions, which, when executed on at least one processor, cause the at least one processor to carry out the actions described herein, as performed by the third network node 18. The computer program product 1405 may be stored on a computer-readable storage medium 1406, e.g., a disc, a universal serial bus (USB) stick or similar. The computer-readable storage medium 1406, having stored thereon the computer program product, may comprise the instructions which, when executed on at least one processor, cause the at least one processor to carry out the actions described herein, as performed by the third network node 18. In some embodiments, the computer-readable storage medium may be a transitory or a non-transitory computer-readable storage medium. Thus, embodiments herein may disclose the third network node 18 for handling communication in a communication network, wherein the third network node 18 comprises processing circuitry and a memory, said memory comprising instructions executable by said processing circuitry whereby said third network node 18 is operative to perform any of the methods herein.

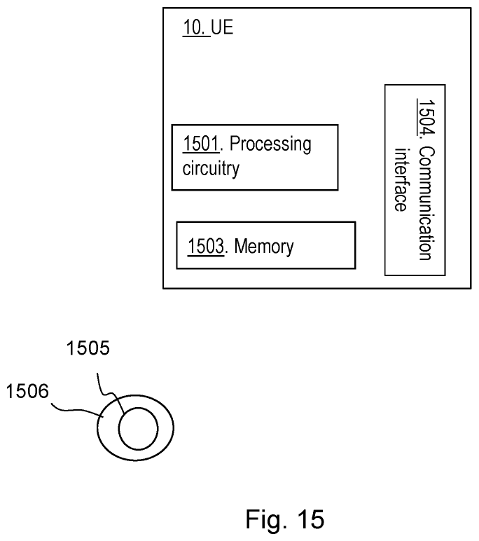

FIG. 15 are block diagrams depicting the UE 10, in two embodiments, for handling communication of the UE 10 in the communication network 1, for example, handling a service, according to embodiments herein.

The UE 10 may comprise processing circuitry 1501, e.g., one or more processors, configured to perform the methods herein.

The UE 10 and/or the processing circuitry 1501 is configured to send to the third network node 18, the request for a first network node supporting a service related to AR and/or XR.

The UE 10 and/or the processing circuitry 1501 is configured to receive the response from the third network node 18 with the indication indicating the one or more first network nodes supporting the service related to AR and/or XR. The UE 10 and/or the processing circuitry 1501 may be configured to receive the list of first network nodes from the third network node 18.

The UE 10 and/or the processing circuitry 1501 may be configured to select a first network node from the list.

The UE 10 may comprise a memory 1503. The memory 1503 comprises one or more units to be used to store data on, such as data packets, thresholds, signal strengths/qualities, measurements, indications, SIP messages, events and applications to perform the methods disclosed herein when being executed, and similar. Furthermore, the UE 10 may comprise a communication interface 1504 such as comprising a transmitter, a receiver, a transceiver and/or one or more antennas.

The methods according to the embodiments described herein for the UE 10 are respectively implemented by means of e.g. a computer program product 1505 or a computer program, comprising instructions, i.e., software code portions, which, when executed on at least one processor, cause the at least one processor to carry out the actions described herein, as performed by the UE 10. The computer program product 1505 may be stored on a computer-readable storage medium 1506, e.g. a disc, a universal serial bus (USB) stick or similar. The computer-readable storage medium 1506, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication in a communication network, wherein the UE 10 comprises processing circuitry and a memory, said memory comprising instructions executable by said processing circuitry whereby said UE 10 is operative to perform any of the methods herein.

In some embodiments a more general term “network node” is used and it can correspond to any type of radio-network node or any network node, which communicates with a UE and/or with another network node.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), IoT capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. NR, Wi-Fi, LTE, LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

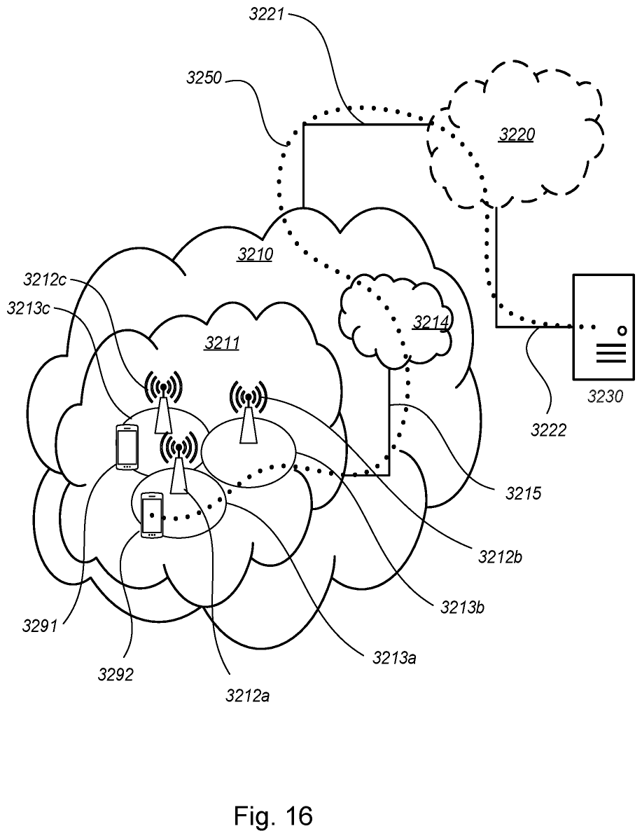

With reference to FIG. 16, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 16 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

In some embodiments, the telecommunication network 3210 includes one or more Open-RAN (ORAN) network nodes. An ORAN network node is a node in the telecommunication network 3210 that supports an ORAN specification (e.g., a specification published by the O-RAN Alliance, or any similar organization) and may operate alone or together with other nodes to implement one or more functionalities of any node in the telecommunication network 3210, including one or more network nodes and/or core network nodes.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes facilitate direct or indirect connection of UE, such as by connecting UEs (one or more of which may be generally referred to as UEs 3291, 3292) to the core network over one or more wireless connections.

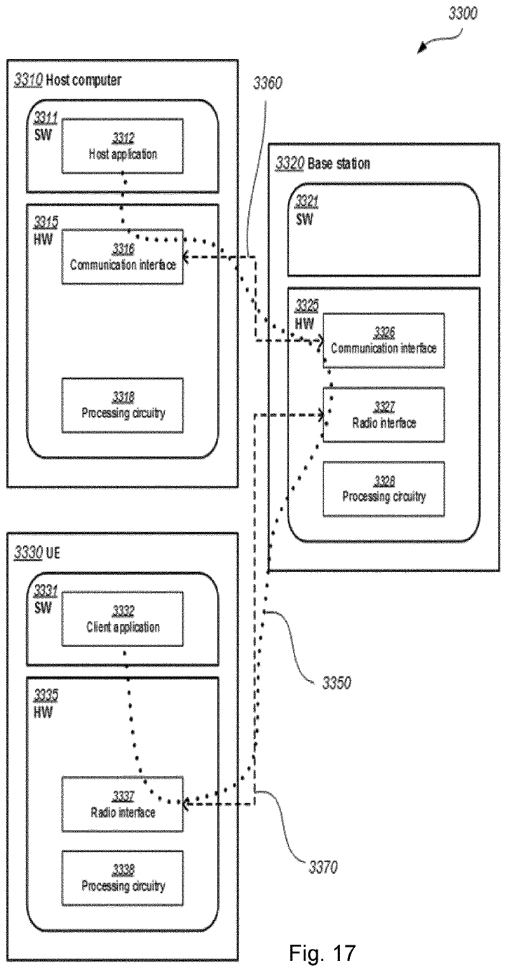

Example implementations, in accordance with an embodiment, of the UE, base station and host computer discussed in the preceding paragraphs will now be described with reference to FIG. 17. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 17) served by the base station 3320. The communication interface 3326 may be configured to facilitate a connection 3360 to the host computer 3310. The connection 3360 may be direct or it may pass through a core network (not shown in FIG. 17) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 17 may be identical to the host computer 3230, one of the base stations 3212a, 3212b, 3212c and one of the UEs 3291, 3292 of FIG. 16, respectively. This is to say, the inner workings of these entities may be as shown in FIG. 17 and independently, the surrounding network topology may be that of FIG. 16.

In FIG. 17, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since handover to another PLMN may be handled more efficiently and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

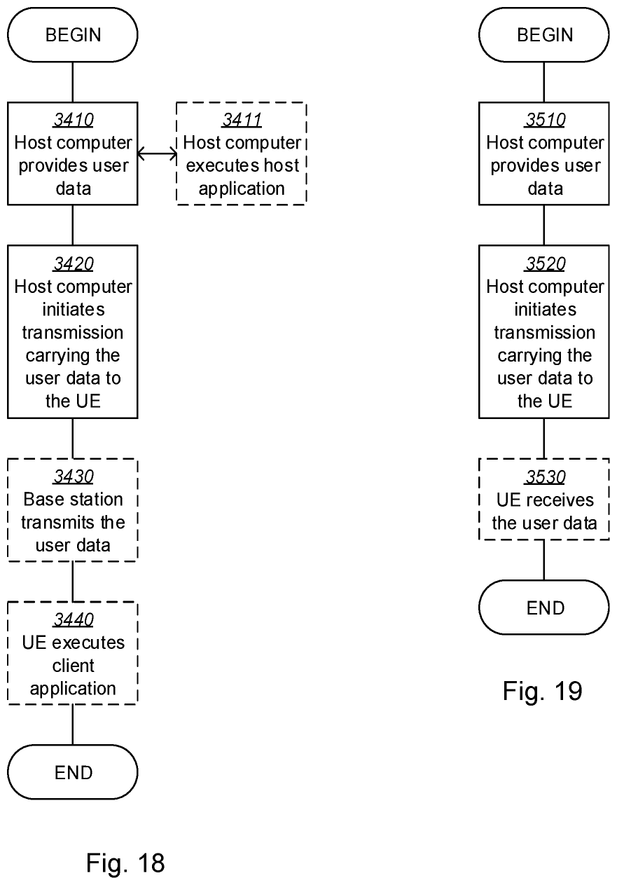

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

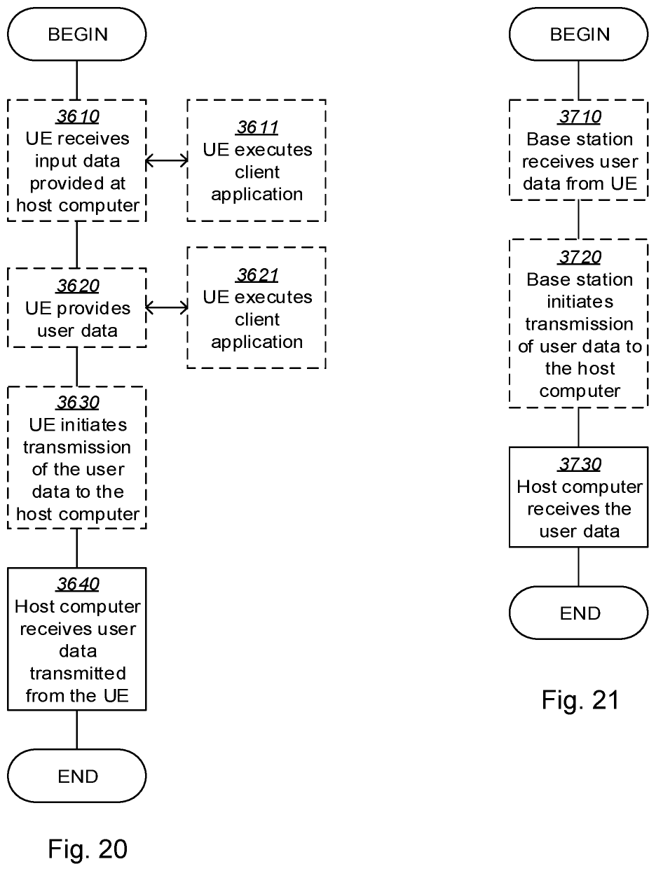

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

### Embodiments Herein:

### Embodiment A1

A method performed by a first network node 15 for handling communications in a communication network, the method comprising
registering at a second network node 16, that the first network node supports a capability associated with a service related to AR.

### Embodiment A2

The method according to embodiment A1, wherein registering comprises transmitting an indication indicating that the first network node supports a capability associated with a service related to AR.

### Embodiment A3

The method according to any of the embodiments A1-A2, comprising
receiving a request from a third network node to initiate a service related to AR for a UE 10.

### Embodiment B1

A method performed by a second network node 16 for handling communications in a communication network, comprising
receiving an indication from a first network node 15, indicating that the first network node supports a capability associated with a service related to AR; and
storing the indication mapped to a node indication of the first network node 15.

### Embodiment B2

The method according to embodiment B1, further comprising
receiving from a third network node one or more requests for one or more network nodes that supports a service related to AR;
retrieving one or more indications of respective network node that supports the service related to AR; and
transmitting to the third network node the one or more indications of respective network node that supports the service related to AR.

### Embodiment C1

A method performed by a third network node 18 for handling communications in a communication network, the method comprising
receiving from a UE, a request for a network node supporting a service related to AR;
obtaining one or more indications of one or more network nodes that supports the service related to AR; and
providing a response to the UE indicating the one or more network nodes.

### Embodiment C2

The method according to embodiment C1, wherein obtaining comprise requesting from a second network node 16 one or more network nodes that supports the service related to AR, or retrieve the one or more indications internally; and receiving a response from the second network node 16, wherein the response comprises the one or more indications indicating one or more first network nodes supporting a service related to AR.

### Embodiment C3

The method according to any of the embodiments C1-C2, comprising
selecting a first network node supporting a service related to AR.

### Embodiment C4

The method according to embodiment C3, comprising providing the response to the UE with a same or different indication indicating the one or more first network nodes supporting the service related to AR.

### Embodiment D1

A method performed by a UE 10 for handling communication of the UE 10 in a communication network; the method comprising
sending to a third network node 18, a request for a network node supporting a service related to AR; and
receiving a response from the third network node 18 with an indication indicating a first network node supporting the service related to AR.

### Embodiment E1

A first network node 15 for handling communications in a communication network, wherein the first network node is configured to
register at a second network node 16, that the first network node supports a capability associated with a service related to AR.

### Embodiment F1

A second network node 16 for handling communications in a communication network, wherein the second network node is configured to receive an indication from a first network node 16, indicating that the first network node supports a capability associated with a service related to AR; and to store the indication mapped to a node indication of the first network node 15.

### Embodiment G1

A third network node 18 for handling communications in a communication network, wherein the third network node is configured to
receive from a UE, a request for a network node supporting a service related to AR;
obtain one or more indications of one or more network nodes that supports the service related to AR; and
provide a response to the UE indicating the one or more network nodes.

### Embodiment H1

A UE 10 for handling communication of the UE 10 in a communication network; wherein the UE is configured to
send to a third network node 18, a request for a network node supporting a service related to AR; and
receive a response from the third network node 18 with an indication indicating a first network node supporting the service related to AR.

### REFERENCES

[1] 3GPP TR 26.998 Support of 5G Glass-type Augmented Reality/Mixed Reality (AR/MR) devices; (Release 17)—https://www.3gpp.org/ftp/Specs/archive/26_series/26.998/26998-h10.zip
[2] 3GPP TR 26.918 Extended Reality (XR) in 5G (Release 17) https://www.3gpp.org/ftp/Specs/archive/26_series/26.918/26918-h00.zip
[3] 3GPP TS 23.228 IP Multimedia Subsystem (IMS); Stage 2 (Release 17)—https://www.3gpp.org/ftp/Specs/archive/23_series/23.228/23228-h30.zip
[4] 3GPP TS 24.229 IP multimedia call control protocol based on Session Initiation Protocol (SIP) and Session Description Protocol (SDP); Stage 3 (Release 17)—https://www.3gpp.org/ftp/Specs/archive/24_series/24.229/24229-h81.zip
[5] GSMA NG.114—https://www.gsma.com/newsroom/resources/ng-114-ims-profile-for-voice-video-and-messaging-over-5gs-v-5-0/
[6] 3GPP TS 24.008 Mobile radio interface Layer 3 specification; Core network protocols; Stage 3 (Release 18)—https://www.3gpp.org/ftp/Specs/archive/24_series/24.008/24008-i00.zip
[7] 3GPP TS 23.501 System architecture for the 5G System (5GS); Stage 2 (Release 17)—https://www.3gpp.org/ftp/Specs/archive/23_series/23.501/23501-h60.zip
[8] 3GPP TS 23.502 Procedures for the 5G System (5GS); Stage 2 (Release 17)—https://www.3gpp.org/ftp/Specs/archive/23_series/23.502/23502-h60.zip
[9] 3GPP TS 29.510 5G System; Network Function Repository Services; Stage 3 (Release 18)—https://www.3gpp.org/ftp/Specs/archive/29_series/29.510/29510-100.zip
[10] 3GPP TS 31.103 Characteristics of the IP Multimedia Services Identity Module (ISIM) application (Release 17)—https://www.3gpp.org/ftp/Specs/archive/31_series/31.103/31103-h00.zip
[11] RFC 3361 Dynamic Host Configuration Protocol (DHCP-for-IPV4). Option for Session Initiation Protocol (SIP) Servers.—https://www.rfc-editor.org/rfc/rfc3361.html
[12] RFC 3319 Dynamic Host Configuration Protocol (DHCPv6) Options for Session Initiation Protocol (SIP) Servers—https://www.rfc-editor.org/rfc/rfc3319.html

### Abbreviations

AR Augmented Reality
AR-SS Augmented Reality Signaling Server
FQDN Fully Qualified Domain Name
IANA Internet Assigned Numbers Authority
NF Network Function
ePCO Extended Protocol Configuration Options
XR extended Reality

1.-5. (canceled)

6. A method performed by a third network node for handling communications in a communication network, the method comprising:
receiving from a user equipment (UE), a request for a first network node supporting a service related to augmented reality (AR) and/or extended reality;
obtaining one or more indications of one or more first network nodes that supports the service related to AR and/or extended reality; and
providing a response to the UE indicating the one or more first network nodes.

7. The method according to claim 6, wherein obtaining the one or more indications comprises: requesting from a second network node one or more first network nodes that supports the service related to AR and/or extended reality and receiving a response from the second network node, wherein the response comprises the one or more indications indicating one or more first network nodes supporting a service related to AR and/or extended reality; or retrieving the one or more indications internally.

8. The method according to claim 6, comprising:
selecting a first network node supporting a service related to AR and/or extended reality.

9. The method according to claim 8, comprising providing the response to the UE with a same or different indication as the one obtained indicating the one or more first network nodes supporting the service related to AR and/or extended reality.

10. A method performed by a user equipment (UE) for handling communication of the UE in a communication network, the method comprising
sending to a third network node, a request for a first network node supporting a service related to augmented reality (AR) and/or extended reality; and
receiving a response from the third network node with an indication indicating a first network node supporting the service related to AR and/or extended reality.

11.-15. (canceled)

16. A third network node for handling communications in a communication network, wherein the third network node is configured to:
receive from a user equipment (UE), a request for a first network node supporting a service related to augmented reality (AR) and/or extended reality;
obtain one or more indications of one or more first network nodes that supports the service related to AR and/or extended reality; and
provide a response to the UE indicating the one or more first network nodes.

17. The third network node according to claim 16, wherein the third network node is configured to obtain the one or more indications by: requesting from a second network node one or more first network nodes that supports the service related to AR and/or extended reality, and receive a response from the second network node, wherein the response comprises the one or more indications indicating one or more first network nodes supporting a service related to AR and/or extended reality; or to retrieve the one or more indications internally.

18. The third network node according to claim 16, wherein the third network node is configured to
select a first network node supporting a service related to AR and/or extended reality.

19. The third network node according to claim 18, wherein the third network node is configured to provide the response to the UE with a same or different indication as the one obtained indicating the one or more first network nodes supporting the service related to AR and/or extended reality.

20. A user equipment, (UE) for handling communication of the UE in a communication network; wherein the UE is configured to:
send to a third network node, a request for a first network node supporting a service related to augmented reality (AR), and/or extended reality; and
receive a response from the third network node with an indication indicating a first network node supporting the service related to AR and/or extended reality.

21. A computer program product comprising a non-transitory computer readable medium storing a computer program comprising instructions, which, when executed on processing circuitry, cause the processing circuitry to carry out the method according to claim 6.

22. (canceled)

23. A computer program product comprising a non-transitory computer readable medium storing a computer program comprising instructions, which, when executed on processing circuitry, cause the processing circuitry to carry out the method according to claim 10.

24. The method according to claim 10, further comprising:
selecting a first network node from the response received from the third network node.

25. The method according to claim 24, further comprising:
using the first network node selected for AR service and/or extended reality service.

26. The UE according to claim 20, further configured to:
select a first network node from the response received from the third network node.

27. The UE according to claim 26, further configured to:
use the first network node selected for AR service and/or extended reality service.
